(19) United States
(12) Patent Application Publication
(10) Pub. No.: US 2011/0050770 A1
(43) Pub. Date: Mar. 3, 2011

(54) LIQUID EJECTING APPARATUS AND MANUFACTURING METHOD THEREOF

(75) Inventor: Kenji OTOKITA, Higashichikuma-gun (JP)

(73) Assignee: SEIKO EPSON CORPORATION, Tokyo (JP)

(21) Appl. No.: 12/862,883

(22) Filed: Aug. 25, 2010

(30) Foreign Application Priority Data
Sep. 3, 2009 (JP) 2009-203437

(51) Int. Cl. B41J 29/38; B23P 17/00

(52) U.S. Cl. 347/11; 29/890.1

(57) ABSTRACT

A liquid ejecting apparatus includes liquid ejecting heads, each ejecting a liquid from a nozzle by driving a pressurizing unit that causes the volume of a pressure chamber that communicates with the nozzle to change. A driving pulse generation unit generates driving pulses that drive the respective pressurizing units. A controller controls the ejection of the liquids by the liquid ejecting heads. Each driving pulse includes an ejection element that causes the pressure chamber to constrict, thereby ejecting liquid from the nozzle, and a retraction element that retracts a meniscus at the nozzle toward the pressure chamber by causing the pressure chamber constricted by the ejection element to expand. The controller sets the ending potential of the retraction element on the liquid ejecting head-by-liquid ejecting head basis so that the shapes of dots formed on a ejection target are made uniform throughout the liquid ejecting heads.

The entire disclosure of Japanese Patent Application No: 2009-203437, filed Sep. 3, 2009 are expressly incorporated by reference herein.

### BACKGROUND

1. Technical Field

The present invention relates to a liquid ejecting apparatus such as an ink jet printer or the like and a manufacturing method thereof, and particularly relates to a liquid ejecting apparatus provided with a plurality of liquid ejecting heads and a manufacturing method thereof.

2. Related Art

A liquid ejecting apparatus is an apparatus that, for example, is provided with a liquid ejecting head capable of ejecting a liquid from a nozzle, and that ejects various types of liquid from this liquid ejecting head. An image recording apparatus such as an ink jet printer (called simply a “printer” hereinafter) that is provided with an ink jet recording head (called simply a “recording head” hereinafter) as its liquid ejecting head and that records images and so on by causing ink in liquid form to be ejected from the nozzle in the recording head and impact upon a recording medium such as a recording sheet (an ejection target) can be given as a representative example of such a liquid ejecting apparatus. Meanwhile, in addition to such image recording apparatuses, liquid ejecting apparatuses are recently being applied in various manufacturing apparatuses, such as apparatuses for manufacturing color filters for liquid crystal displays.

Some printers, which are a type of the stated liquid ejecting apparatus, include a plurality of recording heads. For example, in the printer disclosed in JP-A-2009-137091, a head row is configured by arranging a plurality of recording heads in the widthwise direction of the ejection target such as recording paper or the like. Each recording head is configured so as to be capable of ejecting ink of each of the colors C (cyan), M (magenta), Y (yellow), and K (black). In the case where line drawings, text, or natural images are to be printed onto the ejection target by the plurality of recording heads, there is a risk of a drop in the image quality of the printed image or the like if there is variance in the ejection properties, or in other words, the mass, flight speed, and so on of the ejected ink, throughout the recording heads. Accordingly, with such past printers, influence on images and so on due to variance in the ejection properties between recording heads has been suppressed by adjusting the number of ejections in accordance with ejection error on a recording head-by-recording head basis.

However, there are cases where the shape of the dots formed when ink impacts upon the ejection target differ from head to head, and thus there has been a problem in that the image quality of printed images and so on is not improved even if the number of ejections is adjusted on a head-by-head basis as described above.

### SUMMARY

An advantage of some aspects of the invention is to provide a liquid ejecting apparatus capable of reducing differences in dot shapes among heads in a configuration that includes a plurality of liquid ejecting heads, and to provide a manufacturing method for such a liquid ejecting apparatus.

One aspect of the invention is a liquid ejecting apparatus that includes: a plurality of liquid ejecting heads, each ejecting a liquid from a nozzle by driving a pressurizing unit that causes the volume of a pressure chamber that communicates with the nozzle to change; a driving pulse generation unit that generates driving pulses that drive the respective pressurizing units; and a controller that controls the ejection of the liquids by the liquid ejecting heads. Each driving pulse includes at least an ejection element that causes the pressure chamber to constrict so as to cause the liquid to be ejected from the nozzle, and a retraction element that retracts the meniscus at the nozzle toward the pressure chamber by causing the pressure chamber constricted by the ejection element to expand; and the controller setting the ending potential of the retraction element on a liquid ejecting head-by-liquid ejecting head basis so that the shapes of dots formed on a ejection target are made uniform throughout the liquid ejecting heads.

According to this configuration, the ending potentials of the retraction elements are set on a liquid ejecting head-by-liquid ejecting head basis, and the shapes of the dots formed upon the ejection target are made uniform throughout the liquid ejecting heads, or in other words, the shapes of the dots match or are similar in each head; this prevents the image quality of the image formed on the ejection target or the like from dropping.

In the aforementioned aspect, it is desirable for each liquid ejecting head to be configured so as to be capable of ejecting a plurality of types of liquid having different hues, and for the controller to set the ending potentials of the retraction elements of the driving pulses so that the shapes of dots of the same color formed on the ejection target are uniform throughout the liquid ejecting heads.

According to this configuration, in a configuration capable of ejecting a plurality of types of liquid of different hues, color unevenness or the like is prevented by making the shapes of dots of the same color uniform, making it possible to contribute to higher image quality in the printed images and so on.

In addition, in the aforementioned aspect, a configuration can be employed in which each liquid ejecting head is configured so that the shape of dots formed on the ejection target can be changed; an information storage unit that stores information regarding the ending potentials of the retraction elements in association with the liquid ejecting heads and dot shapes is provided; and the controller sets the ending potentials of the retraction elements of the driving pulses corresponding to the dot shapes on a liquid ejecting head-by-liquid ejecting head basis by referring to the information regarding the ending potentials of the retraction elements stored in the information storage unit.

According to this configuration, the ending potentials of the retraction elements of the driving pulses corresponding to respective dot shapes are set on a liquid ejecting head-by-liquid ejecting head basis with reference to information regarding the ending potentials of the retraction elements stored in the information storage unit; this makes the shapes of the dots uniform throughout the heads even if the shapes of dots have been changed, and it is thus possible to prevent a problem in which the image quality of the printed image or the like drops.

In addition, another aspect of the invention is a manufacturing method for a liquid ejecting apparatus, the liquid ejecting apparatus including a plurality of liquid ejecting heads that each eject a liquid from a nozzle by driving a pressurizing unit that causes the volume of a pressure chamber that communicates with the nozzle to change, a driving pulse generation unit that generates driving pulses that drive the respective pressurizing units, and a controller that controls the ejection of the liquids by the liquid ejecting heads, the driving pulses including at least an ejection element that causes the pressure chamber to constrict so as to cause the liquid to be ejected from the nozzle and a retraction element that retracts the meniscus at the nozzle toward the pressure chamber by causing the pressure chamber constricted by the ejection element to expand, and the method including: obtaining ending potentials of the retraction elements of the driving pulses on a liquid ejecting head-by-liquid ejecting head and dot shape-by-dot shape basis; and storing, in an information storage unit, information of the ending potentials of the retraction elements obtained in the obtaining in association with respective liquid ejecting heads and dot shapes.

### BRIEF DESCRIPTION OF THE DRAWINGS

The invention will be described with reference to the accompanying drawings, wherein like numbers reference like elements.

FIGS. 1A and 1B are diagrams illustrating the configuration of a printer.

FIG. 2 is a cross-section of the principal constituent elements illustrating the configuration of a recording head.

FIG. 3 is a plan view illustrating the configuration of a nozzle plate.

FIG. 4 is a block diagram illustrating the electrical configuration of a printer.

FIG. 5 is a waveform diagram illustrating the structure of a driving pulse.

FIG. 6 is a chart indicating the correspondence between printing modes, dot shapes, and intermediate voltages.

### DESCRIPTION OF EXEMPLARY EMBODIMENTS

Hereinafter, an embodiment of the invention will be described with reference to the appended drawings. Although various limitations are made in the embodiment described hereinafter in order to illustrate a specific preferred example of the invention, it should be noted that the scope of the invention is not intended to be limited to this embodiment unless such limitations are explicitly mentioned hereinafter. An ink jet recording apparatus (referred to as a “printer”) will be given hereinafter as an example of a liquid ejecting apparatus according to the invention.

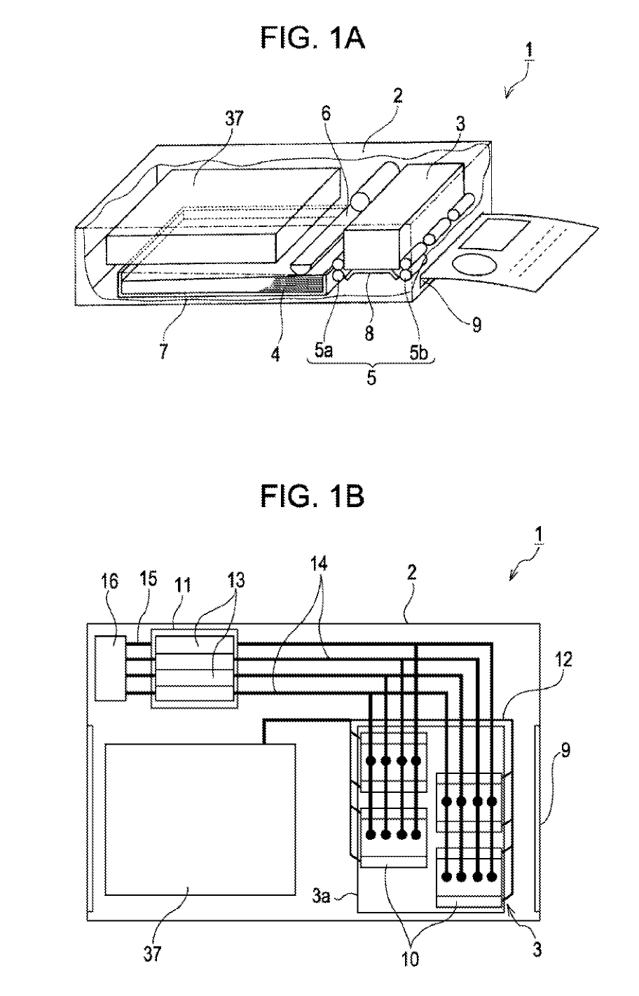

FIG. 1A is a partially transparent perspective view illustrating an example of the configuration of a printer 1 according to the invention, whereas FIG. 1B is a plan view illustrating the internal configuration of the printer 1. As shown in FIG. 1A, the printer 1 of this embodiment includes, within a housing 2, a head unit 3 serving as one type of a liquid ejecting head according to the invention, a paper supply tray 7 that holds recording paper 4 serving as one type of a recording medium (ejection target), a paper supply unit 6 that extracts the recording paper, one sheet at a time, from the paper supply tray 7 and supplies that paper between the head unit 3 and a platen 8, a transport unit 5 that transports the recording paper 4 supplied by the paper supply unit 6 between the head unit 3 and the platen 8, and a printer controller 37 that performs driving control of these elements; the configuration is such that recording can be performed across the entire width of a recording region of the recording paper 4 without the head unit 3 moving relative to the recording paper 4.

The transport unit 5 includes an upstream paper feed roller 5a that pinches the recording paper 4 supplied from the paper supply unit 6 and feeds that paper between the head unit 3 and the platen 8, a paper feed guide (not shown) that configures a supply path when the recording paper 4 is transported, a downstream paper feed roller 5b that feeds the recording paper that has passed between the head unit 3 and the platen 8 toward a discharge opening 9, and a paper feed motor (not shown) that drives both paper feed rollers 5a and 5b; the recording paper onto which recording has been performed by the head unit 3 is discharged from the discharge opening 9.

The head unit 3 is capable of ejecting a plurality of types of liquid having different hues, such as, for example, four-color CMYK (cyan, magenta, yellow, and black) ink, and nozzle rows 35C, 35M, 35Y, and 35K that correspond to the respective colors (a type of nozzle group; see FIG. 3) are disposed orthogonal to the transport direction of the recording paper 4, with the nozzle surfaces positioned so as to face the platen 8. The head unit 3 according to this embodiment is configured of a plurality of recording heads, or to be more specific, is configured of a combination of a total of four recording heads 10 (a type of liquid ejecting head according to the invention). The recording heads 10 are disposed in a unit holder 3a so that the nozzles are, as a whole, arranged at a set arrangement interval when viewed in the direction orthogonal to the transport direction of the recording paper, and so that the recording heads that are adjacent to each other have a two-stepped positioning whereby the positions of those recording heads are shifted so as to alternate in the transport direction of the recording paper. Note that the positioning of the recording heads in the head unit is not limited to the example described here; a configuration in which the recording heads are arranged upon a single straight line can also be employed as long as the nozzles of each recording head can, as a whole, be arranged at a set interval.

Meanwhile, as shown in FIG. 1B, a cartridge holder 11 is provided on one side in the housing 2, the cartridge holder 11 holding an ink cartridge 13 (a type of liquid supply source) in a removable state. In this embodiment, the cartridge holder 11 holds a total of four ink cartridges 13. This ink cartridge 13 is connected to an air pump 16 via air tubes 15, and air is supplied to the interior of each ink cartridge 13 from this air pump 16. The configuration is such that ink is supplied (pressure-transferred) to the recording heads 10 through ink supply tubes 14 due to pressurization within the ink cartridges 13 resulting from the air. In addition, the printer controller 37 and the recording heads 10 are electrically connected by a wire member 12, such as a flexible flat cable, and driving signals and the like from the printer controller 37 are supplied to the recording heads 10 via the wire member 12.

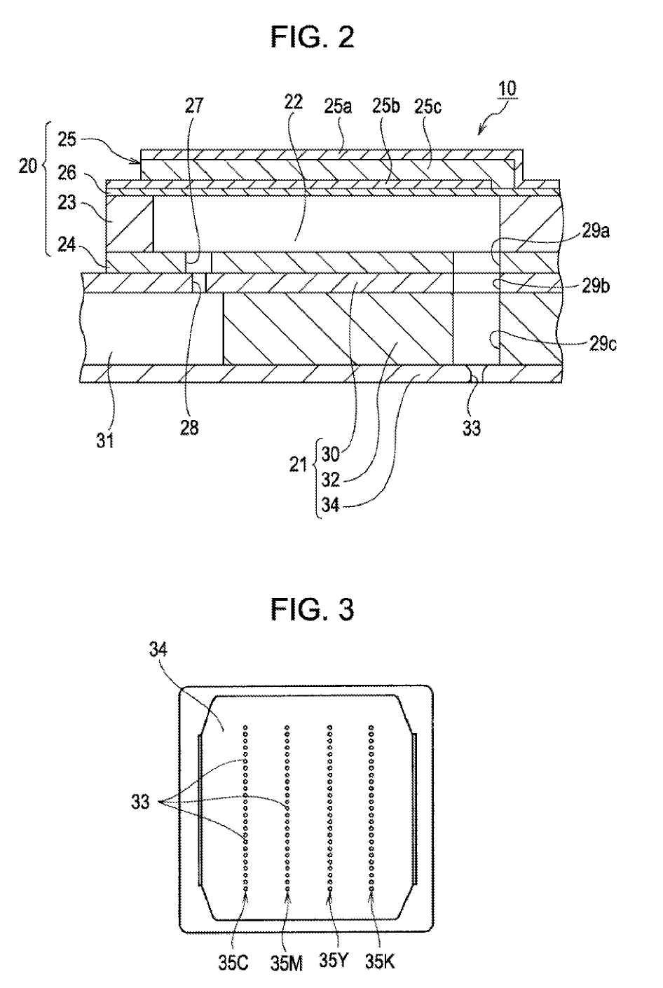

As shown in FIG. 2, each recording head 10 is configured of a pressurizing unit 20 and a flow channel unit 21, which are integrated as a single entity in a stacked state. The pressurizing unit 20 is configured of a pressure chamber plate 23 that partitions a pressure chamber 22, a communication opening plate 24 in which a supply-side communication opening 27 and a first communication opening 29a are provided, and a vibrating plate 26 on which is mounted a piezoelectric element 25; these plates are layered upon each other and integrated as a single entity through firing or the like. Meanwhile, the flow channel unit 21 is configured of a supply opening plate 30 in which a supply opening 28, a second communication opening 29b are formed, a reservoir plate 32 in which a reservoir 31, a third communication opening 29c are formed, and a nozzle plate 34 in which a nozzle 33 is formed, the plates being laminated together in a stacked state.

The nozzle plate 34 is a member created from a metal plate such as a stainless-steel plate, a silicon substrate, or the like. As shown in FIG. 3, this nozzle plate 34 has nozzle rows 35 in which a plurality of nozzles 33 are arranged. The nozzle rows include, for example, 180 nozzles 33, and are provided for each type of ink, or in other words, for each color of ink. To be more specific, a total of four nozzle rows, or a nozzle row 35C corresponding to cyan, a nozzle row 35M corresponding to magenta, a nozzle row 35Y corresponding to yellow, and a nozzle row 35K corresponding to black, are formed in the nozzle plate 34.

The piezoelectric elements 25 are disposed on the outside surface of the vibrating plates 26 on the side opposite to the pressure chambers 22, corresponding to each pressure chamber 22. The piezoelectric element 25 illustrated as an example here is a vibrator having a laterally-vibrating mode, and is configured of a piezoelectric member 25c being sandwiched between a driving electrode 25a and a common electrode 25b. When a driving signal (ejection driving pulse) is applied to the driving electrode of the piezoelectric element 25, an electric field based on a potential difference between the driving electrode 25a and the common electrode 25b is generated. The piezoelectric member 25c is affected by the generated electric field, and deforms in accordance with the strength of the electric field. In other words, as the potential of the driving electrode 25a increases, the piezoelectric member 25c constricts in the direction orthogonal to the electric field, thus causing the vibrating plate 26 to deform so that the volume of the pressure chamber 22 decreases.

With the recording head 10 configured as described above, ink is drawn from the ink cartridge 13 via the ink supply tubes 14, and after the interior from the reservoir 31 to the nozzle 33 is filled with ink, driving pulses are applied between the common electrode 25b and driving electrode 25a corresponding to the pressure chamber 22 as a result of a driving signal from the printer itself; this causes the piezoelectric element 25 to distort laterally, and the volume of the pressure chamber 22 fluctuates as a result. The pressure of the ink within the pressure chamber 22 fluctuates as a result of the volume of the pressure chamber 22 fluctuating, and ink is ejected (discharged) from the nozzle 33 by controlling this pressure fluctuation.

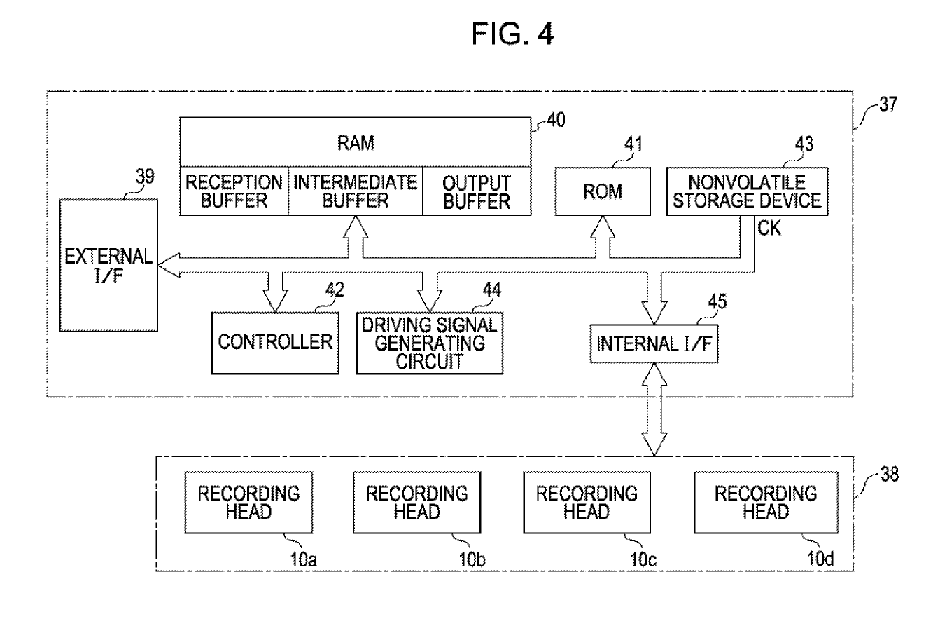

FIG. 4 is a block diagram illustrating the electrical configuration of the printer 1. This printer 1 includes the printer controller 37 and a print engine 38. The printer controller 37, meanwhile, includes an external interface (external I/F) 39 that receives print data and the like from an external device such as a host computer (not shown); a RAM 40 that stores various types of data and so on; a ROM 41 in which routines and so on for various types of data processing are stored; a controller 42, configured of a CPU or the like, that electrically controls the various constituent elements; a nonvolatile storage device 43 (a type of information storage unit) configured of a flash ROM; a driving signal generation circuit 44 (a type of driving pulse generation unit) that generates a driving signal COM; and an internal interface (internal I/F) 45 for transmitting ejection data expanded based on the print data, driving signals, and so on to the print engine 38, the constituent elements being connected to each other by an internal bus.

The RAM 40 is used as a reception buffer, an intermediate buffer, an output buffer, a work memory (not shown), or the like. Print data received by the external I/F 39 from an external device is temporarily stored in the reception buffer. Intermediate code data obtained through conversion performed by the controller 42 is stored in the intermediate buffer. Ejection data to be sent to the recording heads 10 is expanded in the output buffer. The ROM 41 stores various types of control routines executed by the controller 42, font data and graphics functions, various types of procedures, and so on.

The controller 42 expands print data transmitted from an external device such as a host computer or the like into ejection data corresponding to the nozzles 33 of the recording head 10, and transmits that ejection data to an ejection unit 17. The print data transmitted from the external device is matrix data in which values of pixels that make up an image (tone values) are arranged in matrix form, and the value of each pixel is expressed as, for example, 8-bit data. In other words, the tone value of each pixel is expressed as a binary value corresponding to a value from 0, which indicates the darkest state, to 255, which indicates the lightest state. Meanwhile, in the case of a color image, a single piece of print data is configured of matrix data of the respective colors red (R), green (G), and blue (B). In the case where the print data expresses a color image, the controller 42 carries out a color conversion process. The print data of the color image is made up of three colors, or R, G, and B, and the controller 42 converts the print data expressing the RGB colors into the CMYK four-color color space used by the recording head 10 based on a color conversion table that indicates the correspondence relationship between the colors in RGB and the colors in CMYK.

The post-color conversion print data is made up of CMYK matrix data resulting from the color conversion, and each pixel employs a value of, for example, 256 tones. Meanwhile, the recording head 10 is capable of recording four tones, expressed by a large dot, a medium dot, a small dot, and no dot. Accordingly, the controller 42 converts the post-color conversion print data into data expressed through these four tones. To be more specific, the post-color conversion print data is converted into data expressing whether to form a large, medium or small dot, or whether to form no dot at all, or in other words, whether a dot is present or absent. This conversion process is also referred to as a halftoning process. In this halftoning process, the controller 42 determines dot formation rates for the large, medium, and small dots upon the recording paper 4 based on a lookup table stored in the ROM 41. This lookup table defines, in correspondence with the tone values of the pixels in the print data, percentages at which the respective sizes of dots are formed in a virtual pixel region (a region in which a pixel is formed) in the recording medium. The formation percentage of each dot in the pixel region is that dot's formation rate. Note that such a lookup table is, as described hereinafter, provided, for example, for each of modes of the printer, such as a normal printing mode, a printing mode of a line drawings/text/halftone dot, etc., a natural image (high resolution) printing mode, a natural image (low resolution) printing mode, and so on.

The ejection data expanded based on the print data is stored in the output buffer of the RAM 40. When one line's worth of ejection data (SI) is obtained, that ejection data is serially transferred to each recording head 10 of the head unit 3 via the internal I/F 45. When the one line's worth of ejection data is then transmitted from the output buffer, the content of the intermediate buffer is expunged and conversion is performed on the next intermediate code data. Then, each recording head 10 performs operations for ejecting ink from the nozzles 33 based on the received ejection data.

The aforementioned driving signal generation circuit 44 generates the driving signal COM for supply to the recording heads 10 under the control of the controller 42. The driving signal COM includes driving pulses for driving the piezoelectric element 25 serving as a pressurizing unit and ejecting ink, as exemplified in FIG. 5. Waveform data serving as the basis of the driving pulses is stored in a waveform memory (not shown), and as will be described later, waveforms are corrected as necessary based on IDs stored in the nonvolatile storage device 43. Ink is ejected from the nozzle 33 each time this driving pulse is applied to the piezoelectric element 25. The driving pulse shown as an example in FIG. 5 is a small dot driving pulse DP for forming a small dot. This small dot driving pulse DP is configured of a voltage waveform including: a front expansion element p1 in which the potential changes (drops) from a base potential VB to a first intermediate expansion potential VM1 at a comparatively low degree of slope; a rear expansion element p2 in which the potential changes (drops) from the first intermediate expansion potential VM1 to an expansion potential VL at a sharper slope than the front expansion element p1; an expansion hold element p3 in which the expansion potential VL is held for a predetermined amount of time; a constriction element p4 (a type of ejection element) in which the potential changes (rises) from the expansion potential VL to a constriction potential VH at a sharp slope; a constriction hold element p5 in which the constriction potential VH is held for a predetermined amount of time; a retraction element p6 in which the potential changes (drops) from the constriction potential VH to a second intermediate potential VM2; a retraction maintenance element p7 in which the second intermediate potential VM2 is maintained for a predetermined amount of time; a damping expansion element p8 in which the potential changes (drops) from the second intermediate potential VM2 to a damping expansion potential Vr; a damping hold element p9 in which the damping expansion potential Vr is held for a predetermined amount of time; and a damping return element p10 in which the potential returns from the damping expansion potential Vr to the base potential VB.

When the aforementioned small dot driving pulse DP is applied to the piezoelectric element 25, first, the central portion of the piezoelectric element 25 bends in the direction away from the pressure chamber 22 due to the front expansion element p1, and as a result, the pressure chamber 22 expands from a normal volume corresponding to the base potential VB to a first intermediate expanded volume corresponding to the first intermediate expansion potential VM1. The meniscus of the nozzle 33 is comparatively slowly retracted toward the pressure chamber 22 as a result of this expansion. Next, the piezoelectric element 25 bends more quickly in the direction away from the pressure chamber 22 due to the rear expansion element p2. Accordingly, the pressure chamber 22 suddenly expands from the first intermediate expanded volume to a maximum expanded volume corresponding to the expansion potential VL, and the meniscus is greatly retracted toward the pressure chamber 22. This expanded state of the pressurizing chamber 22 is maintained during the interval in which the expansion hold element p3 is supplied. After this, the central portion of the piezoelectric element 25 bends in the direction toward the pressure chamber 22 due to the constriction element p4. The pressure chamber 22 suddenly constricts from the maximum expansion volume to a constricted volume corresponding to the constriction potential VH as a result of the displacement of the piezoelectric element 25. The ink within the pressure chamber 22 is suddenly pressurized as a result of the sudden constriction of the pressure chamber 22, and the ink is ejected from the nozzle 33 as a result. The constricted state of the pressurizing chamber 22 is maintained during the interval in which the constriction hold element p5 is supplied.

Next, the central portion of the piezoelectric element 25 bends in the direction away from the pressure chamber 22 due to the retraction element p6, and the pressure chamber 22 expands from the constriction volume to a second intermediate expanded volume corresponding to the second intermediate potential VM2. Accordingly, the meniscus is retracted toward the pressure chamber 22. This causes the trailing portion of the ink ejected from the nozzle 33 to separate from the meniscus. The second intermediate expanded volume is maintained for a predetermined amount of time due to the retraction maintenance element p7. After this, the central portion of the piezoelectric element 25 bends in the direction away from the pressure chamber 22 due to the damping expansion element p8, and the pressure chamber 22 expands from the second intermediate expanded volume to a damping expanded volume corresponding to the damping expansion potential Vr. Here, the duration pwh of the retraction maintenance element p7 is adjusted so that the damping expansion element p8 is applied to the piezoelectric element 25 at a timing that cancels out residual vibrations after ink ejection, and thus residual vibrations are reduced. Then, after the damping expanded volume that has been maintained for a predetermined amount of time due to the damping hold element p9, the piezoelectric element 25 bends in the direction toward the pressurizing chamber due to the damping return element p10, and the pressure chamber 22 returns from the damping expanded volume to the normal volume as a result.

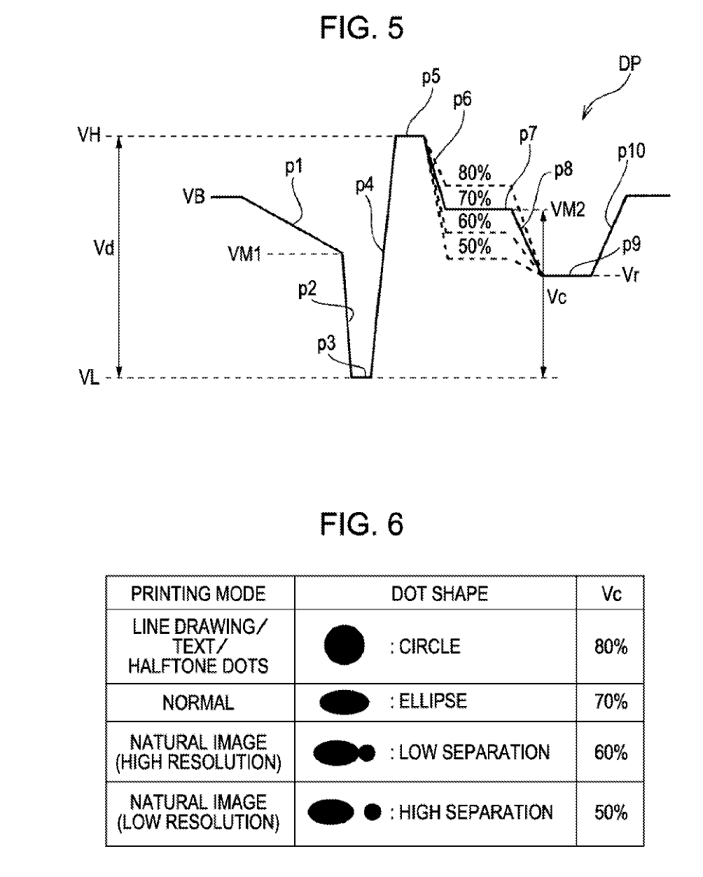

Here, the printer 1 according to the invention is configured so that the shape of the dots formed when the ink impacts upon the ejection target, such as the recording paper 4, can be changed depending on the printing mode. To be more specific, as shown in FIG. 6, the normal mode compliant with all types of image printing regardless of the details of that printing, such as line drawings, natural images, and so on, is set so as to form elliptical dots, whereas a mode for forming images in which comparatively clear contours are required, such as line drawings/text/halftone dots and so on, is set so as to form dots that are close to circles in shape. Meanwhile, in modes for printing natural images such as photographs or the like, a high-resolution mode is set so as to form dot shapes in which the primary ink droplet and a satellite droplet are intentionally separated so that the impact location of the primary ink droplet and the impact location of the satellite droplet are slightly shifted from each other (low separation). Separating the dots in this manner makes coarseness less apparent in the printed image. Meanwhile, the low-resolution mode for printing natural images forms dot shapes in which the impact location of the primary ink droplet and the impact location of the satellite droplet are separated further from each other (high separation). These dots shapes can be switched during the printing process, which is favorable when performing printing in which, for example, a natural image and a line drawings are combined, as with a photograph or the like.

Note that with the printer 1, lookup tables corresponding to these dot shapes are respectively prepared, and a dot formation rate according to the dot shape is set when printing. Through this, even if the dot shape is changed, the hue, darkness, and so on will not fluctuate dramatically in the printed image.

These dot shapes can be controlled by adjusting the ending potential of the retraction element in the driving pulse (in the case of a small dot driving pulse, the second intermediate potential VM2; this will be referred to as a “retraction potential” hereinafter). In other words, in a state immediately following the ejection of ink from the nozzle 33 due to the constriction element p4, where the ink droplet has not separated from the meniscus at the nozzle 33, the extension of ink (trailing tails) in the flight direction is suppressed as the amount of retraction of the meniscus due to the retraction element p6 is reduced, making it possible to bring the shape of the impacted dot close to a perfect circle. Conversely, the trailing tails lengthen as the amount of retraction of the meniscus due to the retraction element p6 is increased, and thus the shape of the impacted dot becomes an ellipse. If the amount of retraction is further increased, the trailing portion of the ink droplet will separate from the primary ink droplet as a satellite droplet, resulting in separated impact dots.

With respect to the retraction potentials corresponding to the respective types of dot shapes, values through which desired shapes can be obtained are determined while observing the dot shapes obtained during examination procedures when manufacturing the printer when actually causing ink to impact upon an ejection target. For example, with a recording head 10 to serve as a reference among the plurality of recording heads 10, in the case of the normal printing mode, the retraction potential of the small dot driving pulse DP (the second intermediate potential VM2) is adjusted so that an intermediate voltage Vc, which represents the potential difference from the expansion potential VL serving as the minimum potential to the retraction potential, is 70% of a driving voltage Vd (the potential difference from the expansion potential VL to the constriction potential VH serving as the maximum potential). As opposed to this, in the case of a printing mode for line drawings or the like, the retraction potential is adjusted to that the intermediate voltage Vc is 80% of the driving voltage Vd, resulting in a configuration in which the amount of retraction of the meniscus is less than in the normal printing mode. Accordingly, because the extension in the flight direction of the ink ejected from the nozzle 33 is suppressed, a dot shape that is closer to a perfect circle can be obtained. Meanwhile, in the case of the high-resolution mode, the retraction potential is adjusted so that the intermediate voltage Vc is 60%. Accordingly, the amount of retraction of the meniscus is greater than in the normal mode, and thus the ink extends in the flight direction; as a result, the trailing portion of the ink separates from the primary droplet as a satellite droplet and impacts on the ejection target. Finally, in the case of the low-resolution mode, the retraction potential is adjusted so that the intermediate voltage Vc is 50%, resulting in a configuration in which the amount of retraction of the meniscus is greater than in the high-resolution mode. By adjusting the retraction potential in this manner so as to obtain a more suitable dot shape in accordance with the printing mode, contours, for example, are clear in line drawings and the like, and in natural images, higher image qualities can be obtained through the suppression of visually-perceptible coarseness in the images.

Incidentally, in a configuration including a plurality of recording heads 10, as in the printer 1 according to this embodiment, there are situations where the same impact dot shape for the recording heads differs from recording head to recording head, and there is a risk that this difference in dot shapes will negatively affect the image quality of printed images and the like. In other words, if the dot shapes differ from recording head to recording head, there is a risk that a sense of graininess (a visually-perceptible grainy coarseness), differences in hue, or unevenness in darkness occur in the printed image, leading to a drop in the image quality. Accordingly, with the printer 1 according to the invention, the retraction potentials of the driving pulses can be individually adjusted from recording head to recording head, so as to make the dot shapes uniform among the recording heads of which the head unit 3 is configured.

In other words, during the aforementioned examination procedures, a process for obtaining the retraction potential of each recording head 10 of which a single head unit 3 is configured (a potential obtainment process) is carried out on an individual basis. To be more specific, an operation for actually ejecting ink using the small dot driving pulse DP and observing the dot formed upon the ejection target is performed a plurality of times while changing the retraction potential, thus obtaining the retraction potential through which the desired dot shape is obtained. Note that in the case of a printer that uses a plurality of types of driving pulses for different sized dots (for example, a large dot driving pulse, a medium dot driving pulse, and a small dot driving pulse), the stated operations are performed for each driving pulse, thus obtaining the retraction potentials corresponding to the various dot shapes for the driving pulses. Meanwhile, in the case of a printer configured to eject a plurality of types of ink of different hues, the stated operations are furthermore carried out for each color (for each nozzle row), thus obtaining the retraction potentials corresponding to the various dot shapes and colors for the driving pulses.

If the retraction potentials have been obtained on a recording head-by-recording head basis in this manner, those potentials are then handled as IDs; recording heads and dot shapes are then associated with each other and are stored in the nonvolatile storage device 43 serving as an information storage unit (an information storage process). Meanwhile, in the case where a plurality of types of driving pulses for which the sizes of the dots differ, the stated IDs are also associated with those driving pulses. Furthermore, in the case of a configuration in which a plurality of types of ink having different hues are used, the IDs are also associated with those colors. As these IDs, or in other words, as the information regarding the ending potentials of the retraction elements, the obtained retraction potential values may be used as-is; alternatively, the ratio of the intermediate voltage Vc relative to the driving voltage of the driving pulse may be used, or vector data (slope and length) of the retraction element p6 may be used. Alternatively, information such as deviation or the like relative to the retraction potential of a single recording head 10 serving as a reference may be employed.

With the printer 1 configured in this manner, when printing an image or the like onto an ejection target such as recording paper, the controller 42 refers to the IDs stored in the nonvolatile storage device 43 and sets the retraction potentials of the driving pulses on an individual recording head-by-recording head basis by controlling the driving signal generation circuit 44, in accordance with the selected printing mode, the driving pulse used, and so on. In other words, the waveform of a driving pulse used as a reference is corrected. By ejecting ink using a driving pulse corrected in this manner, the shapes of the dots formed upon the ejection target are made uniform throughout the recording heads. In other words, the shapes of the dots are made to match, or to be similar, throughout the recording heads. As a result, a drop in the quality of the image or the like that is printed can be prevented. In particular, in the case of a configuration in which a plurality of inks of different hues can be ejected, as with the printer 1 according to this embodiment, making the dot shapes of the same color ink uniform contributes to higher qualities in printed images or the like. Furthermore, even in the case where the dot shapes have been changed in accordance with the printing mode, the dot shapes are made uniform throughout the recording heads, and thus it is possible to prevent a problem in which the image quality of the printed image or the like drops.

Although a so-called laterally-vibrating piezoelectric element 25 is described as an example of a pressurizing unit in the aforementioned embodiments, it should be noted that the pressurizing unit is not limited thereto, and, for example, a so-called longitudinally-vibrating piezoelectric element can be employed as well. In such a case, the direction of the change in the potential of the driving pulse illustrated in FIG. 5, or in other words, the vertical direction of the waveform, is inverted.

In addition, the driving pulse is not limited to the aforementioned embodiment; as long as the driving pulse includes an ejection element that causes the pressure chamber to constrict so as to eject a liquid from the nozzle and a retraction element that retracts the meniscus at the nozzle toward the pressure chamber by causing the pressure chamber constricted by the ejection element to expand, a pulse with any form may be employed.

Furthermore, although an ink jet printer 1, which is an example of a liquid ejecting apparatus, is described as an example in the foregoing, the invention can be applied to other liquid ejecting apparatuses in which thickening of the ejecting liquid is an issue. For example, the invention can also be applied in display manufacturing apparatuses for manufacturing color filters for liquid-crystal displays and so on. In such display manufacturing apparatuses, liquids having R (red), G (green), and B (blue) coloring materials are ejected from coloring material ejecting heads. Meanwhile, in electrode manufacturing apparatuses, electrode materials are ejected in liquid form from electrode material ejection heads.

What is claimed is:

1. A liquid ejecting apparatus comprising:
a plurality of liquid ejecting heads, each ejecting a liquid from a nozzle by driving a pressurizing unit that causes the volume of a pressure chamber that communicates with the nozzle to change;
a driving pulse generation unit that generates driving pulses that drive the respective pressurizing units; and
a controller that controls the ejection of the liquids by the liquid ejecting heads,
wherein each driving pulse includes at least an ejection element that causes the pressure chamber to constrict so as to cause the liquid to be ejected from the nozzle, and a retraction element that retracts a meniscus at the nozzle toward the pressure chamber by causing the pressure chamber constricted by the ejection element to expand; and
the controller sets the ending potential of the retraction element on the liquid ejecting head-by-liquid ejecting head basis so that the shapes of dots formed on a ejection target are made uniform throughout the liquid ejecting heads.

2. The liquid ejecting apparatus according to claim 1,
wherein each liquid ejecting head is configured so as to be capable of ejecting a plurality of types of liquid having different hues; and
the controller sets the ending potentials of the retraction elements of the driving pulses so that the shapes of dots of the same color formed on the ejection target are uniform throughout the liquid ejecting heads.

3. The liquid ejecting apparatus according to claim 1,
wherein each liquid ejecting head is configured so that the shape of dots formed on the ejection target is able to be changed;
the apparatus further comprises an information storage unit that stores information regarding the ending potentials of the retraction elements in association with the liquid ejecting heads and dot shapes; and
the controller sets the ending potentials of the retraction elements of the driving pulses corresponding to the dot shapes on a liquid ejecting head-by-liquid ejecting head basis by referring to the information regarding the ending potentials of the retraction elements stored in the information storage unit.

4. A manufacturing method for a liquid ejecting apparatus, the liquid ejecting apparatus including a plurality of liquid ejecting heads that each eject a liquid from a nozzle by driving a pressurizing unit that causes the volume of a pressure chamber that communicates with the nozzle to change, a driving pulse generation unit that generates driving pulses that drive the respective pressurizing units, and a controller that controls the ejection of the liquids by the liquid ejecting heads, the driving pulses including at least an ejection element that causes the pressure chamber to constrict so as to cause the liquid to be ejected from the nozzle and a retraction element that retracts a meniscus at the nozzle toward the pressure chamber by causing the pressure chamber constricted by the ejection element to expand, the method comprising:
obtaining ending potentials of the retraction elements of the driving pulses on a liquid ejecting head-by-liquid ejecting head and dot shape-by-dot shape basis; and
storing, in an information storage unit, information of the ending potentials of the retraction elements obtained in the obtaining in association with respective liquid ejecting heads and dot shapes.
